(19) United States
(12) Patent Application Publication
(10) Pub. No.: US 2019/0184619 A1
(43) Pub. Date: Jun. 20, 2019

(54) LONG FIBER REINFORCED THERMOPLASTIC FILAMENT

(71) Applicant: GM GLOBAL TECHNOLOGY OPERATIONS LLC, Detroit, MI (US)

(72) Inventors: Matthew Simonin, Ortonville, MI (US); Leira C Sanchez Quinones, San Sebastian, PR (US); William R Rodgers, BLOOMFIELD TOWNSHIP (US); Ryan Gergely, Fraser, MI (US)

(21) Appl. No.: 15/842,982

(22) Filed: Dec. 15, 2017

(51) Int. Cl. B29C 47/00; B29C 47/10; B29C 47/38; B29C 47/80

(52) U.S. Cl. CPC B29C 47/0014; B29C 47/1045; B29C 47/385; B33Y 70/00; B29C 47/0004; B29C 2947/92209; B29C 47/802

(57) ABSTRACT

A method of manufacturing a long fiber reinforced thermoplastic filament includes disposing a mixture of fibrous material and thermoplastic material into a hopper of an extruder device and introducing the mixture into the extruder and through an extensional flow die to preserve longer fiber lengths. From the extensional flow die the mixture is passed through a drawing die to create the long fiber reinforced filament.

### FIELD

Apparatuses consistent with exemplary embodiments relate to a method for manufacturing material used in 3D printing. More particularly, apparatuses consistent with an exemplary embodiment relate to a method of manufacturing a long fiber reinforced thermoplastic filament.

### BACKGROUND

The statements in this section merely provide background information related to the present disclosure and may or may not constitute prior art.

In the prototyping sector of product development, 3D printing is lauded as being a fast, efficient means of creating parts prior to the parts going into the manufacturing stage of development.

While 3D printing is a viable technology in terms of testing parts for form and fit to make sure that no design and engineering tweaks are necessary before any product is green-lighted for production, there are disadvantages in using the technology as well.

These range from a limited variety of materials available from which to create parts, to concerns over whether the physical properties of the parts will provide useful information relative to its intended application.

In conventional 3D printing, the material of choice is a thermoplastic as it can be deposited in molten layers to form the final part. However, a part created from thermoplastic material has a tendency to have micro-porosity and significant anisotropies which may limit the part's functionality and mechanical properties. It would be useful to develop simpler tools or processes to correct such functional and mechanical deficiencies in thermoplastic materials for 3D printing.

### SUMMARY

One or more exemplary embodiments address the above issue by providing a method for manufacturing material used in 3D printing. More particularly, apparatuses consistent with exemplary embodiments relate to a method of manufacturing a long fiber reinforced thermoplastic filament which among other applications could be used for 3D printing.

According to an aspect of an exemplary embodiment, a method of manufacturing a long fiber reinforced thermoplastic filament for 3D printing includes disposing a mixture of fiber containing material and thermoplastic material into a hopper of an extruder device. Another aspect of the exemplary embodiment includes introducing the mixture of fiber containing material and thermoplastic material into the extruder device. Still another aspect as according to the exemplary embodiment includes passing the mixture of fiber containing material and thermoplastic material through an extensional flow die. Another aspect of the exemplary embodiment includes extruding the mixture of fiber containing material and thermoplastic material through at least one shaping die to create a long fiber filament extrudate.

And a further aspect of the exemplary embodiment wherein the extruder device is a single screw extruder. And another aspect wherein the extruder device is a low compression and low shear extruder. And yet a further aspect includes shredding the fiber containing material before mixing with the thermoplastic material.

Still in accordance with another aspect of the exemplary embodiment, wherein the thermoplastic material is in pellet form. In accordance with another aspect of the exemplary embodiment, wherein the fiber containing material is shredded reinforced nylon. And another aspect of the exemplary embodiment includes drawing the long fiber filament extrudate from the at least one shaping die through a second drawing die.

Yet a further aspect of the exemplary embodiment wherein the at least one shaping die further includes a first extrudate diameter, and the second drawing die having a second extrudate diameter that is smaller than the first extrudate diameter. And another aspect of the exemplary embodiment includes cooling the long fiber filament extrudate after extrusion through the at least one die. And still another aspect includes a long fiber reinforced thermoplastic filament for 3D printing having an average fiber length of 0.3 mm to 10 mm manufactured using the method of manufacturing a long fiber reinforced thermoplastic filament in accordance with the exemplary embodiment.

Further features, aspects and advantages of the present invention will become apparent by reference to the following description and appended drawings wherein like reference numbers refer to the same component, element or feature.

### BRIEF DESCRIPTION OF THE DRAWINGS

The present exemplary embodiment will be better understood from the description as set forth hereinafter, with reference to the accompanying drawings, in which:

FIG. 1A is an illustration of the components of system and process in accordance with an exemplary embodiment;

FIG. 1B is an illustration of an extruding device in accordance with an exemplary embodiment;

FIG. 1C is an illustration of an extensional flow die in accordance with aspects of the exemplary embodiment;

FIG. 2 is an illustration of a flow diagram of a method of manufacturing a long fiber reinforced thermoplastic filament for 3D printing in accordance with the exemplary embodiment; and

FIG. 3 is an illustration of the relationship between reinforcing fiber length and mechanical properties in fiber reinforced materials.

### DETAILED DESCRIPTION OF THE INVENTION

The following description is merely exemplary in nature and is not intended to limit the present disclosure, application, or uses thereof.

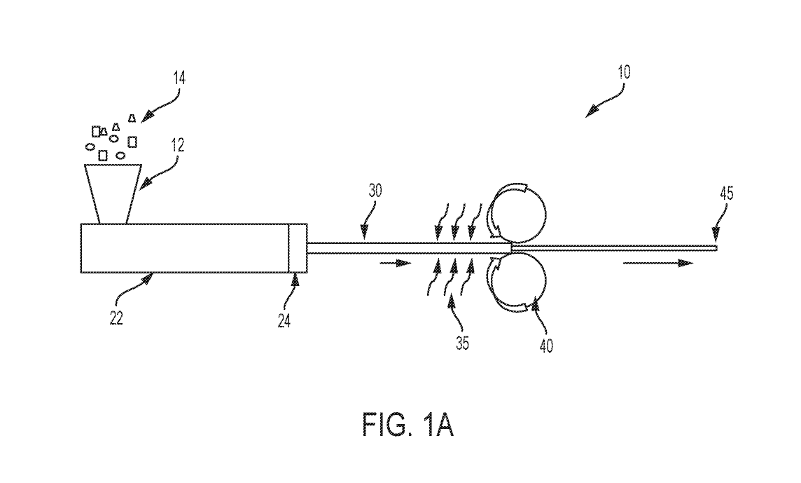

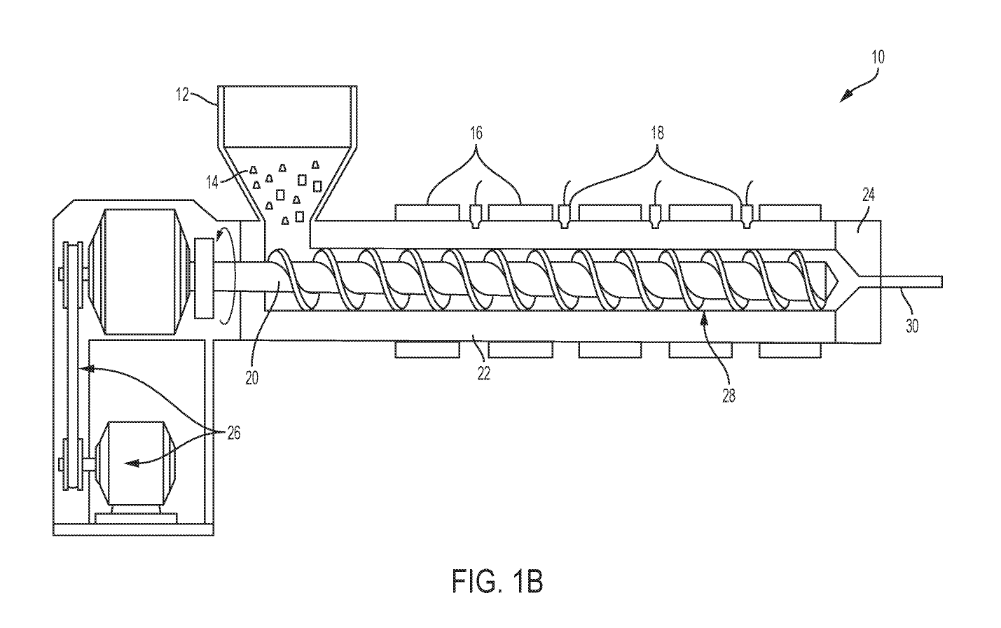

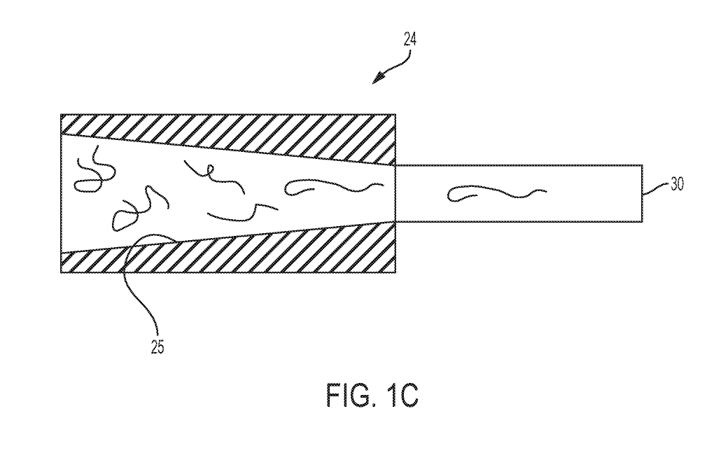

FIG. 1A provides a schematic of the extruder device 10 and process for fabricating long fiber thermoplastic filament in accordance with an exemplary embodiment. A feedstock 14 for such a process would typically consist of thermoplastic polymer and long reinforcing fibers. This feedstock 14 could be individual components or the thermoplastic polymer could already contain the long reinforcing fibers (a thermoplastic composite). The feedstock 14 is fed into the extruder device 10 through a hopper 12 or more advanced feed system such as a gravimetric starve feeder. The material is then homogenized in an extruder designed to minimize fiber breakage. The material is then formed through a die 24 at the end of the extruder device 10, also designed to minimize fiber breakage. The extrudate 30 is then pushed and/or drawn out of the extruder device 10 through one more orifices in the die 24. Controlled heating/cooling apparatuses 35 control the temperature of the extrudate 30 after exiting the extruder device 10 before and/or after one or more optional drawing dies 40. The resulting filament or filaments 45 produced from the process are collected on a reel.

The feedstock 14 is a combination of thermoplastic polymer and reinforcing fiber. This material can be either a pre-combined material containing thermoplastic polymer and reinforcing fiber, or separate polymer and fiber, or a combination thereof. Potential forms of pre-combined material may be, but are not limited to shredded scrap material (e.g. in chip or granular form) or long fiber pellets (e.g. pultruded, push-truded or pellets with a length, and fiber length of roughly 5-25 mm). The thermoplastic polymer of the mixture 14 is provided in the form of pellets, resin, granules, knurdle, sheets, and/or powder. Potential forms of fibers include continuous or chopped virgin (original manufacture), or reclaimed (e.g. post-process/post-consumer, extracted from a polymer matrix).

Scrap material could consist of items such as, but not limited to, molded thermoplastic or fiber reinforced plastic (FRP) parts or trimmings etc. produced in the original part manufacturing process. The original FRP material could consist of continuous (e.g. woven, braided, or unidirectional) or discrete (e.g. long or short) fibers in a thermoplastic matrix. The scrap material (not shown) would be processed by shredding and/or grinding to produce material of reduced size (e.g. chips ˜5-25 mm) for feeding into the extruder. The chips consist of both polymer and fiber.

Materials may consist of both a thermoplastic polymer and reinforcing fiber. The thermoplastic polymer (matrix) may include, but is not limited to: polyamide (PA), polyetheretherketone (PEEK), polyetherketone (PEK), polyphenylene sulfide (PPS), polyethersulfone (PES), thermoplastic polyurethane (TPU), polypropylene (PP), co-polymers thereof, and combinations thereof. The reinforcing fiber may include but is not limited to: carbon fibers, glass fibers, basalt fibers, para-aramid fibers, meta-aramid fibers, polyethylene fibers, and combinations thereof. Fiber loadings may be from 10 weight percent to up to 60 weight percent, more specifically 15 to 50 weight percent, more specifically 20 to 45 weight percent.

FIG. 1B provides a schematic of the additional components of an extruder device 10 for fabricating long fiber thermoplastic composite filament for 3D printing in accordance with an exemplary embodiment. The extruder device 10 is designed to alleviate fiber breakage/attrition. Possible example extruder types to limit the fiber breakage may include but are not limited to low shear, or low compression types. Furthermore, it could employ a single screw, tangential twin screw, non-intermeshing twin-screw, conical twin screw, or reciprocating single screw (Buss Kneader) designs. The specific design of each screw would be adjusted to minimize fiber attrition. The feed of extrudate 30 from the extruder device 10 could be continuous, or the extruder device 10 may be of a reciprocating type where a charge of molten material is built up at the end of the extruder device 10 and pushed through the exit die 24 when a particular charge mass is achieved. The extruder device 10 in accordance with aspects of the exemplary embodiment is a single screw extruder device or any type of low compression, low shear extruder device that will not commute the length of the fiber material within the feedstock 14 to any great extent. The extruder device 10 may incorporate existing technology for mixing homogenizing or melting material that could perform these functions while minimizing fiber breakage (e.g. a Buss kneader).

The extruder device 10 includes heating elements 16 and thermocouples 18 for producing heat into and monitoring the temperature of the extruder device 10. An extrusion screw 20 is disposed within a barrel 22 of the extruder device 10 and is configured such that the feedstock mixture 14 of fiber containing material and thermoplastic material is pushed through the barrel 22 from the material feed hopper 12 to at least one shaping die 24 at the opposite end of the barrel 22. The barrel 22 and or extrusion screw 20 could possess convergent or divergent features to manipulate the material and induce heating and homogenization while minimizing fiber breakage.

As the extrusion screw 20 is turned by a motor and pulley system 26 such that the mixture 14 is pushed through the barrel 22 while being heated by the heating elements 16 which causes the mixture 14 to melt to become a molten fibrous thermoplastic composite material 28. The molten thermoplastic composite material 28 containing long reinforcing fibers is ultimately forced through the at least one die 24 to create a long fiber filament extrudate 30. The at least one shaping die 24 would be a type to minimize fiber breakage, e.g. an extensional flow die (e.g. FIG. 1C). The extensional flow die 24 may possess a gradual angle 25 to reduce fiber breakage, in contrast to a simple plate die with a shorter and steeper angle (not shown). The at least one die 24 may contain a single or multiple orifices for creating a single or multiple extrudate filaments.

In accordance with aspects of an exemplary embodiment, the long fiber filament extrudate 30 may be drawn from the at least one shaping die 24 located at the end of the extruder through one or more rotating drawing dies 40 wherein the at least one shaping die 24 has a first extrudate diameter, and the second drawing die has a second extrudate diameter that is smaller than the first extrudate diameter. Drawing the long fiber filament extrudate 30 to a smaller diameter by the drawing die from the first shaping die 24 will operate to further align filaments within the extrudate 30. Furthermore, the drawing die 40, or series of drawing dies could consolidate the extrudate 30 to reduce porosity.

After exiting the extruder device 10 the extrudate 30 can again be drawn to further reduce the diameter to a desired diameter for 3D printing, typically 3.0 mm or 1.5 mm. Shaping die 24 and drawing die 40 design can also facilitate a range of filament diameters that are continuous. The drawing process may include additional heating and/or cooling after the extruder device. Drawing has multiple advantages. First, the diameter of the at least one shaping die 24 can be increased, which reduces the pressure and energy necessary to extrude the material. In addition, the larger die diameter reduces shear on the fibers thereby reducing fiber breakage. Drawing the filament also increases its mechanical properties, e.g., strength, stiffness, strain to failure, making it more robust for handling and feeding into a 3D printer. It is appreciated that the primary objective in designing the parts of the extruder device 10 is that each part is optimized for reducing fiber breakage.

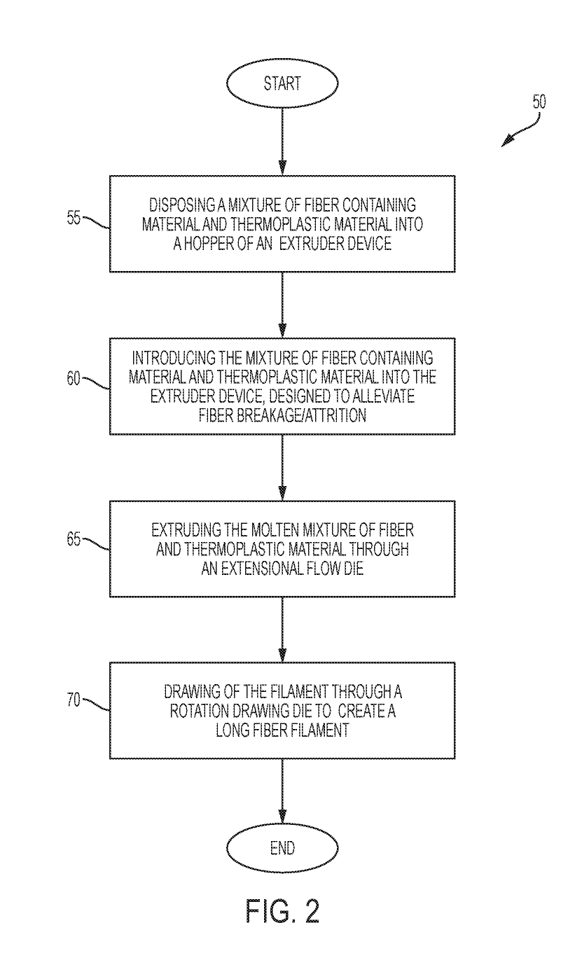

Referring now to FIG. 2, an illustration of a flow diagram 50 of a method of manufacturing a long fiber reinforced thermoplastic filament in accordance with the exemplary embodiment is provided. The method begins at block 55 with disposing a mixture of fiber containing material and thermoplastic material into a hopper of an extruder device. Next, at block 60, the method continues with introducing the mixture of fiber containing material and thermoplastic material into the extruder device, designed to alleviate fiber breakage/attrition. At block 65, the process continues with extruding the molten mixture of fiber and thermoplastic material through an extensional flow die, and at block 70 with drawing of the filament through a rotation drawing die to create a long fiber filament.

Using the combination of a low compression, low shear extruder device and an extensional flow die 24 allows for preservation of long fibers in the extrudate 30 and the long fiber reinforced thermoplastic filament 45, resulting in higher mechanical properties than typical short fiber reinforced 3D printing filament.

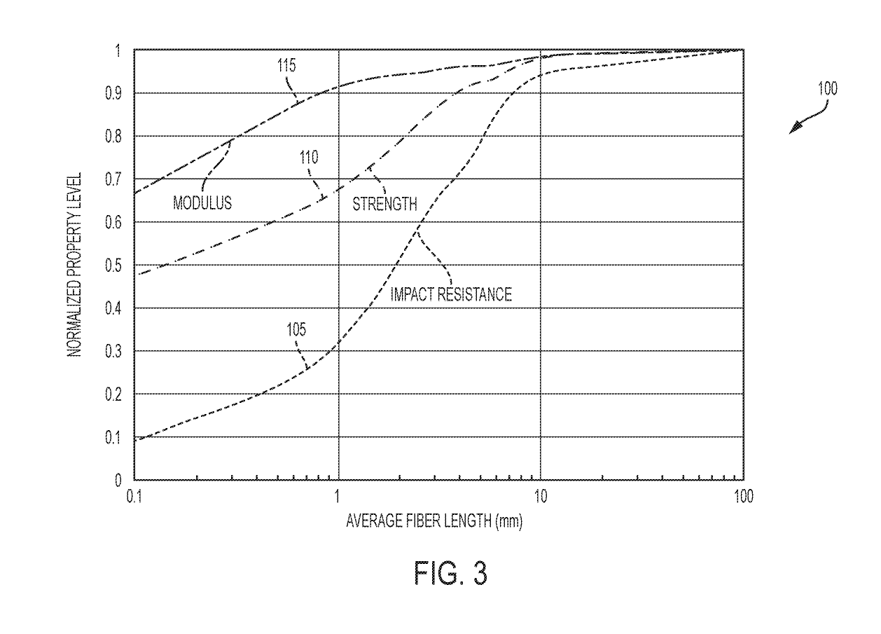

Referring to FIG. 3, an illustration 100 of the effect of fiber length on mechanical properties is provided. As the length of fiber increases, mechanical properties, i.e., impact resistance 105, strength 110, and modulus 115, are improved. The fibers in long fiber thermoplastic filament would be discontinuous and may have an average fiber length of 0.3 to 10 mm, more specifically 1 to 5 mm, or even more optimally 2.0 to 3 mm. Higher mechanical properties in the 3D printing filament translate into higher mechanical properties in parts produced using the 3D printing filament.

The description of the invention is merely exemplary in nature and variations that do not depart from the essential concept of the invention are intended to be within the scope of the invention. Such variations are not to be regarded as a departure from the spirit and scope of the invention.

What is claimed is:

1. A method of manufacturing a long fiber reinforced thermoplastic filament comprising
disposing a mixture of fiber containing material and thermoplastic material into a hopper of an extruder device;
introducing the mixture of fiber containing material and thermoplastic material into the extruder device;
passing the mixture of fiber containing material and thermoplastic material through the extruder device; and
extruding the mixture of fiber containing material and thermoplastic material through an extensional flow die to create a long fiber filament extrudate.

2. The method of claim 1 wherein the extruder device is a single screw extruder.

3. The method of claim 1 wherein the extruder device is a low compression and low shear extruder.

4. The method of claim 1 further comprising shredding the fiber containing material before mixing with the thermoplastic material.

5. The method of claim 1 wherein the thermoplastic material is in pellet form.

6. The method of claim 1 wherein the fiber containing material is a shredded recycled molded thermoplastic material.

7. The method of claim 1 wherein the fiber material is shredded reinforced nylon.

8. The method of claim 1 further comprising drawing the long fiber filament extrudate from the at least one shaping die through a second drawing die.

9. The method of claim 8 wherein the at least one shaping die further comprises a first extrudate diameter, and the second drawing die having a second extrudate diameter that is smaller than the first extrudate diameter.

10. The method of 1 further comprising cooling the long fiber filament extrudate after extrusion through the at least one die.

11. A method of manufacturing a long fiber reinforced thermoplastic filament comprising:
disposing a mixture of fiber material and thermoplastic material into a hopper of a single screw extruder device;
introducing the mixture of fiber material and thermoplastic material into the single screw extruder device;
passing the mixture of fiber material and thermoplastic material through the single screw extruder device; and
extruding the mixture of fiber material and thermoplastic material through an extensional flow die to create a long fiber filament extrudate.

12. The method of claim 11 wherein the single screw extruder device is a low compression and low shear extruder.

13. The method of claim 11 further comprising shredding the fiber containing material before mixing with the thermoplastic material.

14. The method of claim 11 further comprising drawing the long fiber filament extrudate from the at least one shaping die through a second drawing die.

15. The method of claim 14 wherein the at least one shaping die further comprises a first extrudate diameter, and the second drawing die having a second extrudate diameter that is smaller than the first extrudate diameter.

16. A long fiber reinforced thermoplastic filament for 3D printing having an average fiber length of 0.3 mm to 10 mm manufactured using the method of claim 1.

17. The filament for 3D printing of claim 16 having a fiber length of 1 mm to 5 mm manufactured using the method of claim 1.

18. The filament for 3D printing of claim 16 having a fiber length of 2.0 mm to 3.0 mm manufactured using the method of claim 1.
